(19) United States
(12) Patent Application Publication
(10) Pub. No.: US 2021/0195636 A1
(43) Pub. Date: Jun. 24, 2021

(54) WIRELESS COMMUNICATION DEVICE AND WIRELESS COMMUNICATION METHOD

(71) Applicant: SONY CORPORATION, MINATO-KU, TOKYO (JP)

(72) Inventors: Wei WANG, Nanjing-Jiangsu (JP); Yuan ZHANG, Nanjing, Jiangsu (JP); Pingping XU, Nanjing, Jiangsu (JP); Bingshan HU, Beijing (CN); Penshun LU, Beijing (CN)

(21) Appl. No.: 16/074,401

(22) PCT Filed: Jan. 24, 2017
(86) PCT No.: PCT/CN2017/072474

§ 371 Date: Jul. 31, 2018

(30) Foreign Application Priority Data
Feb. 3, 2016 (JP) 201610076394.8

(51) Int. Cl. H04W 74/08; H04W 72/12; H04W 16/14

(52) U.S. Cl. CPC H04W 74/0808; H04W 16/14; H04W 72/1268

(57) ABSTRACT

Disclosed are a wireless communication device and a wireless communication method. According to one embodiment, a wireless communication device for a base station side comprises a transceiver and one or more processors. The processor is configured to: control, in response to a scheduling request aimed at uplink transmission and sent over a licensed band by a user equipment, the transceiver to inspect a channel in an unlicensed band; control, when the inspected channel is idle, the transceiver to send scheduling information aimed at the channel to the user equipment by means of the licensed band; and control the transceiver to receive uplink data transmission sent by the user equipment using the channel.

### FIELD

The present disclosure generally relates to the field of wireless communications, and in particular to a wireless communication apparatus and a wireless communication method for base station side, as well as a wireless communication apparatus and a wireless communication method for user equipment side.

### BACKGROUND

In the third generation partnership project (3GPP), it is expected to define a global uniform licensed assisted access (LAA) framework, to transmit long term evolution (LTE) data on an unlicensed frequency band. A LAA apparatus using an unlicensed frequency band is inevitable to coexist with another communication apparatus such as a wireless fidelity (Wi-Fi) apparatus.

In the current wireless communication environment, traffics for uploading audio stream data and video stream data are increased year by year. In a communication system, base stations and hotspots are deployed by an operator as planned, while user handsets are randomly distributed. As compared with downlink channel access, collides and conflicts are more likely to occur in uplink channel access. In addition, both self-carrier scheduling and cross-carrier scheduling are supported in uplink LAA. The cross-carrier scheduling scheme takes less time and is more suitable for an equipment-intensive deployment scenario.

### SUMMARY

In the current cross-carrier scheduling scheme, only a user equipment performs Listen-Before-Talk (LBT) before data transmission, while a base station does not detect channels, which cannot guarantee that a channel on receiving side is idle when the base station receives data, thus may result in a reception conflict.

A brief summary of embodiments of the present disclosure is given hereinafter, to provide basic understanding for certain aspects of the present disclosure. It should be understood that, the summary is not exhaustive summary of the present disclosure. The summary is not intended to determine key parts or important parts of the present disclosure, and is not intended to limit the scope of the present disclosure. An object of the summary is only to give some concepts of the present disclosure in a simplified form, as preamble of the detailed description later.

According to an embodiment, a wireless communication apparatus for base station side includes a transceiving device and at least one processor. The processor is configured to: control, in response to a scheduling request for uplink transmission transmitted by a user equipment on a licensed frequency band, the transceiving device to detect a channel on an unlicensed frequency band; control, in a case where the detected channel is idle, the transceiving device to transmit scheduling information for the channel to the user equipment through a licensed frequency band; and control the transceiving device to receive uplink data transmitted by the user equipment via the channel.

According to another embodiment, a wireless communication method for base station side includes the following steps: detecting, in response to a scheduling request for uplink transmission transmitted by a user equipment on a licensed frequency band, a channel on an unlicensed frequency band; transmitting, in a case where the detected channel is idle, scheduling information for the channel to the user equipment through a licensed frequency band; and receiving uplink data transmitted by the user equipment via the channel.

According to yet another embodiment, a wireless communication apparatus for user equipment side includes a transceiving device and at least one processor. The processor is configured to: control the transceiving device to transmit a scheduling request for uplink transmission to a base station on a licensed frequency band; control the transceiving device to receive scheduling information transmitted by the base station on a licensed frequency band, where the scheduling information is transmitted by the base station based on a detection on a channel on an unlicensed frequency band; and control the transceiving device to transmit uplink data to the base station via the channel.

According to still another embodiment, a wireless communication method for user equipment side includes the following steps: transmitting a scheduling request for uplink transmission to a base station on a licensed frequency band; receiving scheduling information transmitted by the base station on a licensed frequency band, where the scheduling information is transmitted by the base station based on a detection on a channel on an unlicensed frequency band; and transmitting uplink data to the base station via the channel.

According to the embodiments of the present disclosure, in the cross-carrier scheduling process, the base station detects a channel on an unlicensed frequency band before scheduling the channel, thus can ensure that the channel is idle when the base station receives uplink transmission, thereby reducing possibility of a reception conflict.

### BRIEF DESCRIPTION OF THE DRAWINGS

The present disclosure may be better understood with reference to the description given in conjunction with drawings hereinafter. The same or similar reference numerals are used to indicate the same or similar components throughout the drawings. The drawings together with the following detailed description are included in the specification, form a part of the specification, and are used to further show preferred embodiments of the present disclosure and explain principles and advantages of the present disclosure by examples. In the drawings:

FIG. 1 is a block diagram showing a configuration example of a wireless communication apparatus for base station side according to an embodiment of the present disclosure;

FIG. 2 is a block diagram showing a configuration example of a wireless communication apparatus for base station side according to another embodiment;

FIG. 3 is a flowchart showing a process example of a wireless communication method for base station side according to an embodiment of the present disclosure;

FIG. 4 is a block diagram showing a configuration example of a wireless communication apparatus for user equipment side according to an embodiment of the present disclosure;

FIG. 5 is a block diagram showing a configuration example of a wireless communication apparatus for user equipment side according to another embodiment;

FIG. 6 is a flowchart showing a process example of a wireless communication method for user equipment side according to an embodiment of the present disclosure;

FIG. 7 is a block diagram showing a configuration example of a wireless communication apparatus for base station side according to an embodiment of the present disclosure;

FIG. 8 is a block diagram showing a configuration example of a wireless communication apparatus for user equipment side according to another embodiment of the present disclosure;

FIG. 9 is a block diagram showing an exemplary structure of a computer for implementing a method and an apparatus according to the present disclosure;

FIG. 10 is a block diagram showing an example of a schematic configuration of a smart phone to which the technology of the present disclosure may be applied;

FIG. 11 is a block diagram showing an example of a schematic configuration of an eNB (evolution node B) to which the technology of the present disclosure may be applied;

FIG. 12 is an explanatory diagram for illustrating an example of a process of cross-carrier scheduling and uplink data transmission performed between a base station and a user equipment;

FIG. 13 is a signaling flowchart for illustrating an example of a process of cross-carrier scheduling and uplink data transmission performed between a base station and a user equipment;

FIG. 14 is an explanatory diagram for illustrating another example of a process of cross-carrier scheduling and uplink data transmission performed between a base station and a user equipment;

FIG. 15 is a signaling flowchart for illustrating another example of a process of cross-carrier scheduling and uplink data transmission performed between a base station and a user equipment;

FIG. 16 is a schematic diagram showing uplink data transmission performed between a base station and a user equipment;

FIG. 17 is an explanatory diagram showing a configuration of a predetermined time period for broadcasting a channel occupancy signal by base station side; and

FIG. 18 is an explanatory diagram showing an intensive deployment scenario and interference between an LAA apparatus and a Wi-Fi apparatus.

### DETAILED DESCRIPTION OF EMBODIMENTS

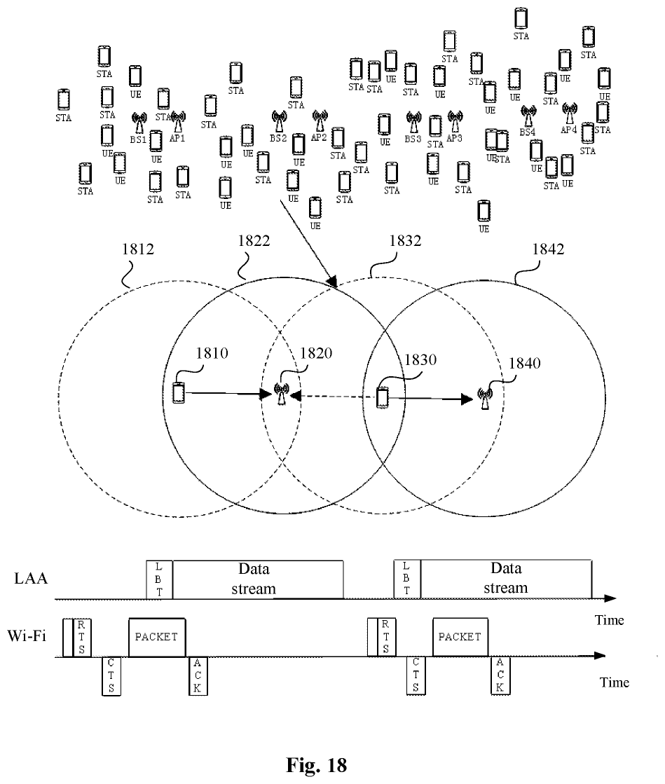

Before a specific description of the embodiments of the present disclosure, an example of an application scenario according to an embodiment of the present disclosure is briefly described with reference to FIG. 18.

An exemplary situation of intensive deployment is shown in the upper part of FIG. 18, where UE indicates a user equipment performing LTE communication, BS1 to BS4 indicate LTE base stations, STA indicates a user equipment performing Wi-Fi communication, and AP1 to AP4 indicate Wi-Fi access points. It should be noted that although a Wi-Fi apparatus is described as an apparatus interfering with an LAA apparatus in the example, the embodiment of the present disclosure is not limited thereto. For example, an apparatus that may interfere with the LAA apparatus may also be, for example, a radar apparatus or the like.

For clarity of illustration, an LTE user equipment 1810, an LTE base station 1820, a Wi-Fi user equipment 1830 and a Wi-Fi access point 1840 are shown in the middle part of FIG. 18 to illustrate interferences among these apparatus. Signal coverage of the user equipment 1810, the base station 1820, the user equipment 1830 and the access point 1840 are respectively indicated by 1812, 1822, 1832 and 1842.

A schematic representation of uplink data transmission between the user equipment 1810 and the base station 1820 as well as data transmission between the user equipment 1830 and the access point 1840 are shown in the lower part of FIG. 18. LBT indicates Listen-Before-Talk performed on a channel on an unlicensed frequency band in LAA communication, RTS indicates a request transmission frame in a Wi-Fi communication, CTS indicates a Clear-to-Send frame in the Wi-Fi communication and ACK indicates an acknowledgment frame in the Wi-Fi communication.

It can be seen that in a case where a same unlicensed frequency band is used in the Wi-Fi communication and the LAA communication, the LTE user equipment 1810 cannot detect any signal of the Wi-Fi user equipment 1830 when performing LBT. However, the signal transmitted by the Wi-Fi user equipment 1830 may cause a conflict to uplink data transmission between the LTE user equipment 1810 and the LTE base station 1820.

Embodiments of the present disclosure are described with reference to the drawings hereinafter. Elements and features described in one drawing or one embodiment of the present disclosure may be combined with elements and features described in one or more other drawings or embodiments. It should be noted that, indication and description of components and processing which are irrelevant to the present disclosure or well known for those skilled in the art are omitted in the drawings and illustrations for clarity.

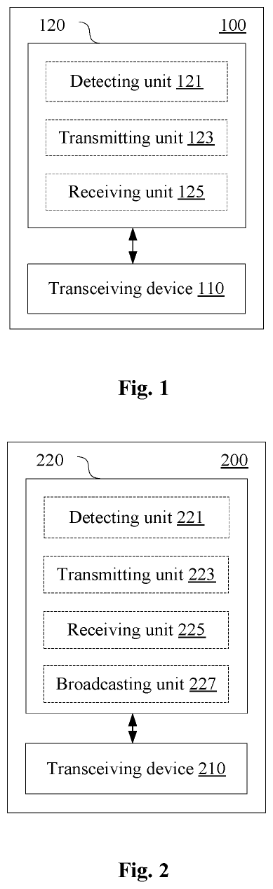

As shown in FIG. 1, a wireless communication apparatus 100 for base station side according to an embodiment includes a transceiving device 110 and a processor 120. The processor 110 includes a detecting unit 121, a transmitting unit 123 and a receiving unit 125. It should be noted that although the detecting unit 121, the transmitting unit 123 and the receiving unit 125 are shown as functional modules in FIG. 1, it should be understood that functions of the detecting unit 121, the transmitting unit 123 and the receiving unit 125 may also be implemented by the processor 120 as a whole, and may not be necessarily implemented by discrete physical components in the processor 120. In addition, although the processor 120 is shown by one block in FIG. 1, the communication apparatus 100 may include multiple processors. The functions of the detecting unit 121, the transmitting unit 123 and the receiving unit 125 may be distributed onto the multiple processors, such that the multiple processors cooperate to perform the functions. In addition, units of the processor 120 are described as the detecting unit 121, the transmitting unit 123 and the receiving unit 125 for the sake of brevity, which indicates that the detecting unit 121, the transmitting unit 123, and the receiving unit 125 are configured to control the transceiving device 110 to perform detection, transmission and reception respectively, rather than that the detecting unit 121, the transmitting unit 123 and the receiving unit 125 perform the detection, the transmission and the reception themselves.

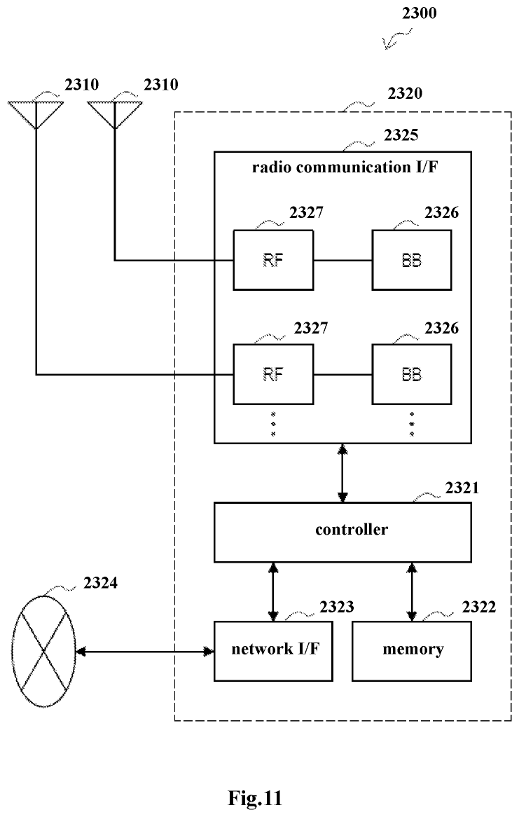

The transceiving device 110 can perform operations such as channel detection, signal transmission and signal reception under control of the processor 110. The transceiving device 110 may be implemented by, for example, a radio communication interface described later with reference to FIG. 11 and may have a configuration known in the field, thus a detailed description of which is omitted here.

The detecting unit 121 of the processor 120 is configured to control the transceiving device 110 to detect a channel on an unlicensed frequency band in response to a scheduling request for uplink transmission transmitted by a user equipment on a licensed frequency band.

It should be noted that, in the embodiment, the channel may be detected directly without performing LBT.

In addition, in the embodiment, the channel is detected in response to the scheduling request for the uplink transmission transmitted by the user equipment. A purpose of detecting the channel is to avoid a channel conflict when receiving uplink data as a receiving side.

The transmitting unit 123 of the processor 120 is configured to control, in a case where the detected channel is idle, the transceiving device 110 to transmit scheduling information for the channel to the user equipment through a licensed frequency band.

In a case of transmitting scheduling information through an unlicensed frequency band, a single transmission of scheduling information may be failed and a retransmission is required. In contrast, according to the embodiment, the scheduling information is transmitted on the licensed frequency band after detecting the channel, such that probability of successful transmission of the scheduling information is increased. Therefore, the user equipment can quickly receive a scheduling result, and then performs LBT and uplink data transmission. The shortened response time of the process can lead to a further reduced probability of a channel conflict when the base station receives uplink data.

The receiving unit 125 of the processor 120 is configured to control the transceiving device 110 to receive the uplink data transmitted by the user equipment via the channel.

According to the embodiment, in response to a scheduling request from a user equipment received on a licensed frequency band, the base station schedules, on a licensed frequency band, a channel on an unlicensed frequency band, and receives the uplink data on the unlicensed frequency band. That is, transmission of scheduling information and data transmission are performed on different frequency bands, that is, a cross-carrier scheduling scheme is adopted. Different from the above-described existing cross-carrier scheduling scheme, according to the embodiment of the present disclosure, the base station performs detection on a channel on a unlicensed band before scheduling the channel, thus can ensure that the channel is idle when the base station receives the uplink transmission, thereby reducing probability of a reception conflict.

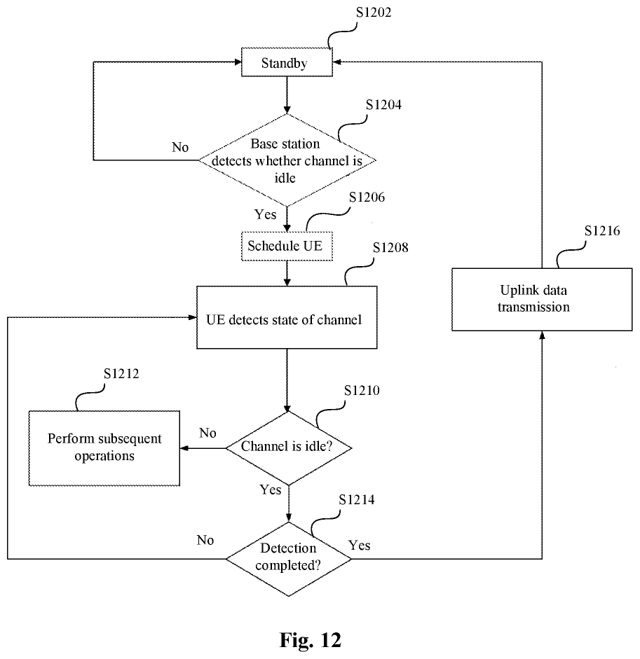

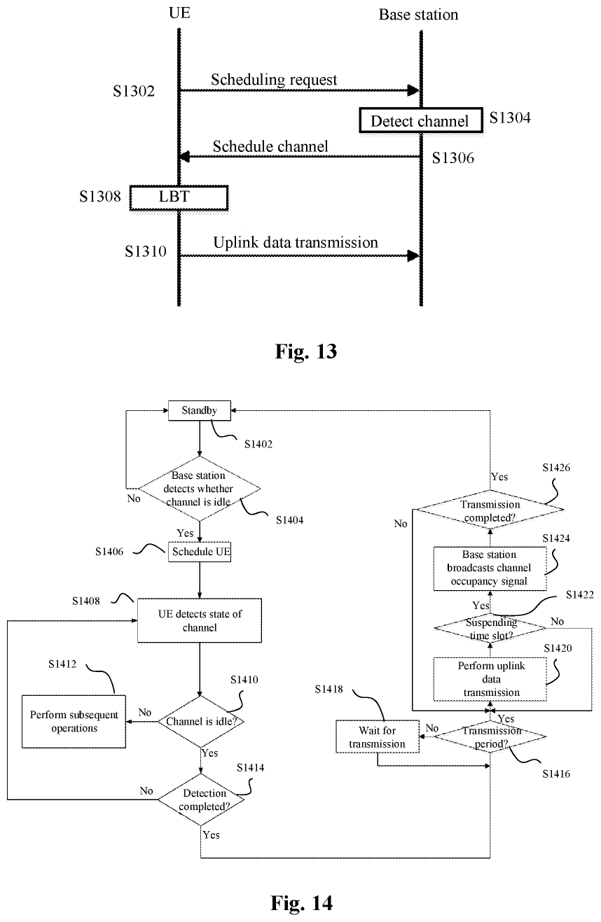

Next, an example of a process of cross-carrier scheduling and uplink data transmission performed between a base station and a user equipment is described with reference to FIG. 12 and FIG. 13. It should be understood that the embodiment of the present disclosure is not limited to specific details in the following example.

FIG. 12 is an explanatory diagram for illustrating an example of a process of cross-carrier scheduling and uplink data transmission performed between a base station and a user equipment (UE).

In S1202, for example, in response to a scheduling request for uplink data transmission from the UE, the process proceeds to S1204 where the base station detects whether a channel is idle.

In a case where a detection result indicates that the channel is occupied (for example, by a Wi-Fi apparatus), the base station may wait, and may, for example, detect again after a predetermined time period.

Alternatively, according to an embodiment, in a case where the detection result indicates that the channel is occupied (or the channel is still occupied after the predetermined time period), the channel may not be scheduled to the UE. In this case, for example, a channel on a licensed frequency band may be scheduled to the user rather than performing the uplink data transmission with the LAA method.

In a case where the detection result indicates that the channel is idle in S1204, the scheduling is performed for the UE in S1206.

Next, in S1208, the UE detects a state of the channel, for example, the UE performs LBT on the scheduled channel.

In a case where the channel is occupied (“No” in S1210), subsequent operations are performed in S1212, for example, a new channel scheduling request is sent.

In a case where the channel is idle (“Yes” in S1210), if the detection is not completed (“No” in S1214), the process of detecting the channel (for example, including a back-off process described later with reference to an embodiment on user equipment side) is continued; if the detection is completed (“Yes” in S1214), uplink data transmission is performed via the channel in S1216.

FIG. 13 is a signaling flowchart for illustrating an example of a process of cross-carrier scheduling and uplink data transmission performed between a base station and a user equipment.

In S1302, the UE transmits a scheduling request to the base station.

In S1304, the base station detects a channel on an unlicensed frequency band.

In S1306, the base station transmits scheduling information to the UE.

In S1308, the base station performs LBT on the scheduled channel.

In S1310, uplink data transmission is performed.

In another aspect, in the uplink data transmission, different from the Wi-Fi frame format for example, the LAA follows an LTE technology where a centralized scheduling access method is adopted, in which a longer time is taken for one-way transmission and no reverse protection strategy is provided. This means that the receiving side (the base station) does not transmit any signal during a long receiving process, thereby may result in a conflict with control frames and data frames transmitted by surrounding Wi-Fi apparatus. To solve this problem, according to an embodiment of the present disclosure, the base station side suspends reception of uplink data for a predetermined time period during the reception of the uplink data and broadcasts a channel occupancy signal via the used channel on the unlicensed frequency band.

As shown in FIG. 2, an information processing apparatus for base station side according to the embodiment includes a transceiving device 210 and at least one processor 220. The processor 210 includes a detecting unit 221, a transmitting unit 223, a receiving unit 225 and a broadcasting unit 227.

Configurations of the transceiving device 210, the detecting unit 221 and the transmitting unit 223 are similar to those of the transceiving device 110, the detecting unit 121 and the transmitting unit 123 described above with reference to FIG. 1, and detailed descriptions thereof are not repeated here.

The receiving unit 225 is configured to control the transceiving device 210 to suspend reception of uplink data for a predetermined time period during the reception of the uplink data.

The broadcasting unit 227 is configured to control the transceiving device 210 to broadcast the channel occupancy signal via the used channel on the unlicensed frequency band.

With the configuration, channel conflicts with other apparatus using the channel, such as a Wi-Fi apparatus, can be avoided during the reception of the uplink data.

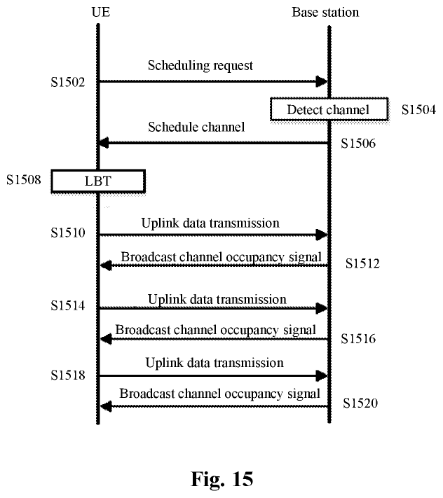

Next, an example of a process of cross-carrier scheduling and uplink data transmission performed between a base station and a user equipment is described with reference to FIG. 14 and FIG. 15.

FIG. 14 is an explanatory diagram showing an example of a process of cross-carrier scheduling and uplink data transmission performed between a base station and a user equipment.

In the process shown in FIG. 14, in S1402, for example, in response to a scheduling request for uplink data transmission from the UE, the process proceeds to S1404. A process of S1402 to S1414 is similar to the process of S1202 to S1214 described above with reference to FIG. 12, and a repeated description thereof is omitted here. A process of the uplink data transmission S1416 to S1426 is described below.

In a time period for transmission (“Yes” in S1416), uplink data transmission is performed in S1420, otherwise, it is waited for transmission in S1418.

During the uplink data transmission, if the current time slot is not a suspending time slot (“No” in S1422), uplink data transmission is continued. In addition, if the current slot is a suspending time slot (“Yes” in S1422), the base station broadcasts a channel occupancy signal in S1424.

In a case where the transmission is completed (“Yes” in S1426), the process returns to a standby state, otherwise, the data transmission is continued.

FIG. 15 is a signaling flow chart showing an example of a process of cross-carrier scheduling and uplink data transmission performed between a base station and a user equipment.

A process of S1502 to S1508 shown in FIG. 15 are similar to the process of S1302 to S1308 described above with reference to FIG. 13, and detailed description thereof is omitted here.

During a process of the uplink data transmission in S1510 to S1518, the base station broadcasts the channel occupancy signal in a predetermined time period (S1512, S1516 and S1520).

According to an embodiment, the predetermined time period is preset by a system to which the base station belongs. In addition, a configuration of the predetermined time period may be the same as that of at least one other base station in the system to which the base station belongs. For example, base stations in the system may broadcast channel occupancy signals during a same time period, and all apparatus in the system synchronously transmit channel occupancy signals, thereby avoiding channel conflicts among base stations in the system.

For example, a length and an interval of the predetermined time period for the user equipment to suspend transmission of the uplink data and for the base station to transmit the channel occupancy signal may be preset by the system. The base station and the user equipment in the system are only required to perform corresponding operations in a designated time slot without transmitting a signaling for notifying temporarily. The system can configure the predetermined time period based on an actual operating environment.

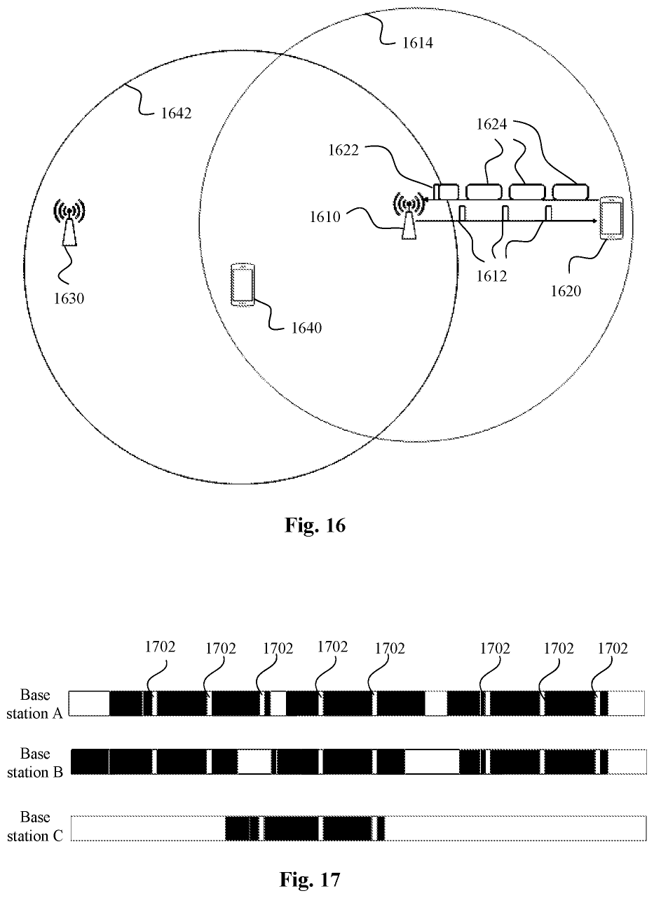

FIG. 16 is a schematic diagram showing uplink data transmission performed between a base station and a user equipment.

In FIG. 16, uplink data transmission is performed between an LTE user equipment 1620 and an LTE base station 1610 through the LAA, and a Wi-Fi user equipment 1640 and a Wi-Fi access point 1630 are existed nearby. 1614 indicates signal coverage of the LTE base station 1610, 1642 indicates signal coverage of the Wi-Fi user equipment 1640, 1624 indicates uplink data transmission performed between the LTE user equipment 1620 and the LTE base station 1610, and 1612 indicates channel occupancy signals.

During reception of uplink data, the LTE base station 1610 can avoid the Wi-Fi user equipment 1640 from using a corresponding channel by broadcasting channel occupation signals 1612, thereby avoiding a reception conflict of the LTE base station 1610.

FIG. 17 shows an exemplary configuration of a predetermined period time for broadcasting channel occupation signals by multiple base stations in a system.

A base station A, a base station B and a base station C may receive uplink data (indicated by black blocks in FIG. 17) in a same time period, and suspend transmission of the uplink data and broadcast channel occupancy signals in a same time period 1702.

In the above description of the wireless communication apparatus for the base station side according to the embodiment of the present disclosure, some methods and processes are further disclosed. Next, a wireless communication method according to an embodiment of the present disclosure is described without repeating the details described above.

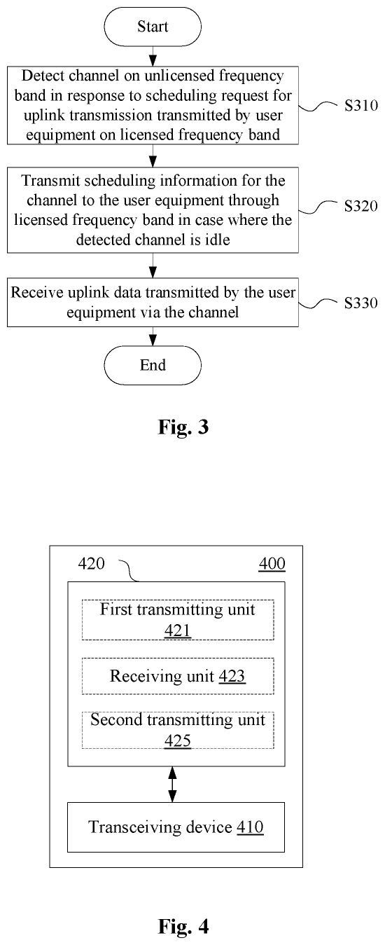

As shown in FIG. 3, a wireless communication method for base station side according to an embodiment includes the following steps S310 to S330.

In S310, a channel on an unlicensed frequency band is detected in response to a scheduling request for uplink transmission transmitted by a user equipment on a licensed frequency band.

In S320, in a case where the detected channel is idle, scheduling information for the channel is transmitted to the user equipment through a licensed frequency band.

In S330, uplink data transmitted by the user equipment via the channel is received.

In addition, the embodiments of the present disclosure further include a wireless communication apparatus and a wireless communication method for user equipment side.

As shown in FIG. 4, a wireless communication apparatus 400 for user equipment side according to an embodiment includes a transceiving device 410 and at least one processor 420.

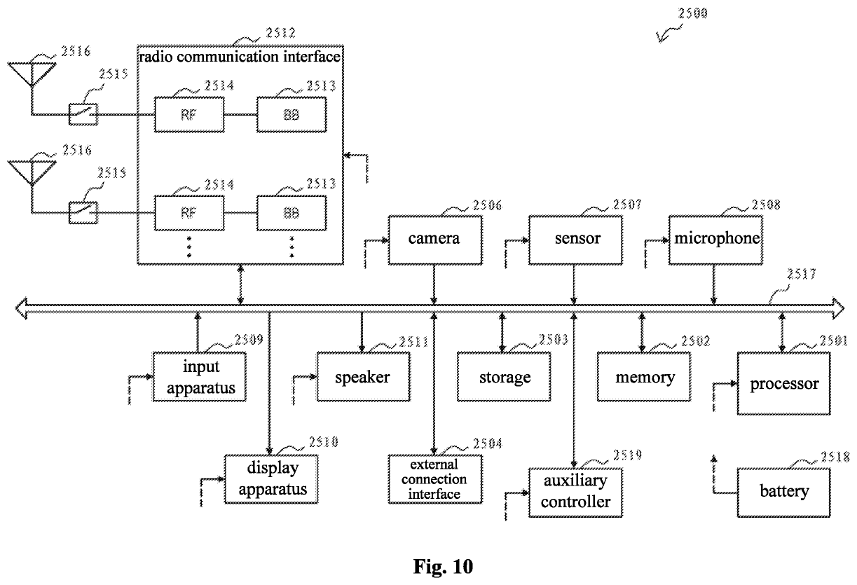

The transceiving device 410 can perform operations such as channel detection, signal transmission and signal reception under control of the processor 410. The transceiving device 410 may be realized by, for example, a radio communication interface described later with reference to FIG. 10, and may have a configuration known in the art, thus a detailed description thereof is omitted here.

The processor 420 includes a first transmitting unit 421, a receiving unit 423 and a second transmitting unit 425.

The first transmitting unit 421 is configured to control the transceiving device 410 to transmit a scheduling request for uplink transmission to the base station on a licensed frequency band.

The receiving unit 423 is configured to control the transceiving device 410 to receive scheduling information transmitted by the base station on a licensed frequency band. The scheduling information is transmitted by the base station based on a detection of the channel on an unlicensed frequency band.

The second transmitting unit 425 is configured to control the transceiving device 410 to transmit uplink data to the base station via the scheduled channel.

According to an embodiment, the second transmitting unit 425 is configured to control the transceiving device 410 to suspend transmission of the uplink data for a predetermined time period during the transmission of the uplink data.

With the configuration, the base station can transmit a channel occupancy signal in a suspending time period to avoid channel conflicts with other apparatus using the channel, such as a Wi-Fi apparatus, during reception of the uplink data.

According to an embodiment, the predetermined time period for suspending the transmission of the uplink data is preset by a system to which the base station belongs.

According to another embodiment, after receiving the scheduling information from the base station, the user equipment may start uplink data transmission immediately, or may perform uplink data transmission after performing LBT.

For example, FIG. 5 shows a configuration example of a wireless communication apparatus for user equipment side according to an embodiment.

As shown in FIG. 5, a wireless communication apparatus 500 according to the embodiment includes a transceiving device 510 and at least one processor 520. The processor 520 includes a first transmitting unit 521, a receiving unit 523, a second transmitting unit 525 and a monitoring unit 527.

Configurations of the transceiving device 510, the first transmitting unit 521, the receiving unit 523 and the second transmitting unit 525 are the same as those of the transceiving device 410, the first transmitting unit 421, the receiving unit 423 and the second transmitting unit 425 above-described with reference to FIG. 4, and detailed descriptions thereof are omitted here.

The monitoring unit 527 is configured to control, after receiving the scheduling information from the base station, the transceiving apparatus 510 to perform LBT on the scheduled channel and trigger, in a case where the channel is idle during an idle channel assessment (CCA) time slot, the second transmitting unit 525 to perform uplink data transmission.

In the above embodiment, the user equipment performs the uplink data transmission after performing the detection during the CCA time slot. In addition, in another embodiment, the user equipment may further be configured to perform the uplink data transmission after performing the back-off process after the CCA time slot.

The back-off process refers to a random back-off process after a delay waiting. For example, a countdown counting method may be used in the process to avoid conflicts. In practical, a back-off number is a random number in a specified range, which may be referred to as a competition window.

For example, according to an example embodiment, the monitoring unit 527 may be configured to control, after receiving the scheduling information, the transceiving device 510 to perform Listen-Before-Talk on the channel and trigger, in a case where the channel is idle during both the idle channel assessment time slot and the subsequent random back-off process, the uplink data transmission. A duration of the random back-off process may be selected randomly in a range of a predetermined competition window.

In another aspect, in a case where the detected channel is occupied during the random back-off process, the monitoring unit 527 may further be configured to perform a new random back-off process with a duration randomly re-selected in the range of the predetermined competition window.

In addition, in a case where the detected channel is occupied during the random back-off process, the monitoring unit 527 may further be configured to adjust a size of the competition window (for example, by doubling the size of the competition window) and perform a new random back-off process with a duration randomly re-selected in a range of the new competition window.

Next, a process example of a wireless communication method for user equipment side according to an embodiment of the present disclosure is described without repeating the details described above.

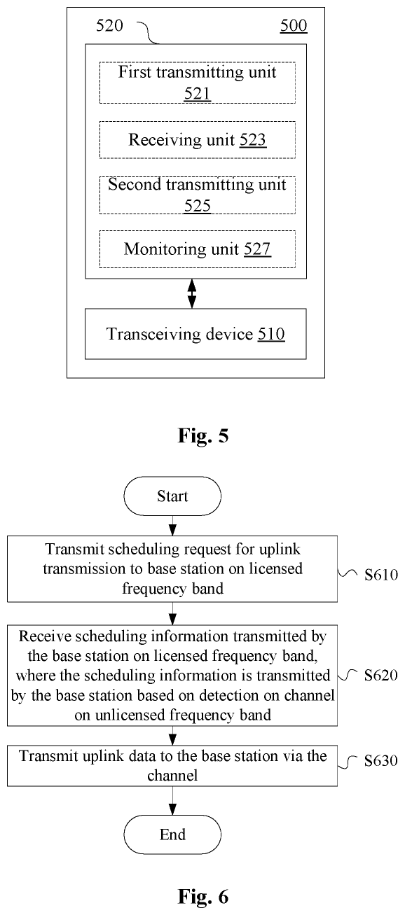

As shown in FIG. 6, in S610, a scheduling request for uplink transmission is transmitted to a base station on a licensed frequency band. Next, in S620, scheduling information transmitted by a base station on a licensed frequency band is received, where the scheduling information is transmitted by the base station based on a detection of a channel on the unlicensed frequency band. Next, in S630, uplink data is transmitted to the base station via the channel.

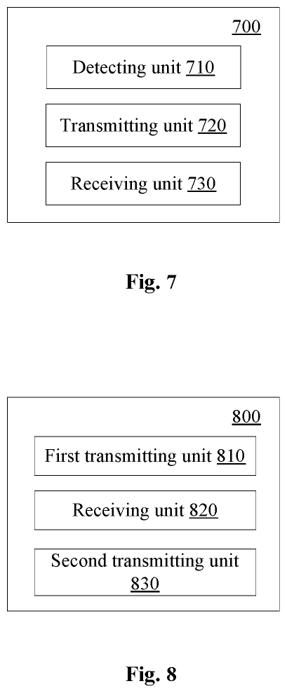

In addition, the embodiments of the present disclosure further include a wireless communication apparatus for base station side. As shown in FIG. 7, a wireless communication apparatus 700 according to the embodiment includes a detecting unit 710, a transmitting unit 720 and a receiving unit 730. The detecting unit 710 is configured to detect a channel on an unlicensed frequency band in response to a scheduling request for uplink transmission transmitted by a user equipment on a licensed frequency band. The transmitting unit 720 is configured to transmit scheduling information for the channel to the user equipment through a licensed frequency band in a case where the detected channel is idle. The receiving unit 730 is configured to receive uplink data transmitted by the user equipment via the channel.

In addition, the embodiments of the present disclosure further include a wireless communication apparatus for user equipment side. As shown in FIG. 8, a wireless communication apparatus 800 according to the embodiment includes a first transmitting unit 810, a receiving unit 820 and a second transmitting unit. The first transmitting unit 810 is configured to transmit a scheduling request for uplink transmission to a base station on a licensed frequency band. The receiving unit 820 is configured to receive scheduling information transmitted by the base station on a licensed frequency band, where the scheduling information is transmitted by the base station based on a detection on a channel on an unlicensed frequency band. The second transmitting unit is configured to transmit uplink data to the base station via the channel.

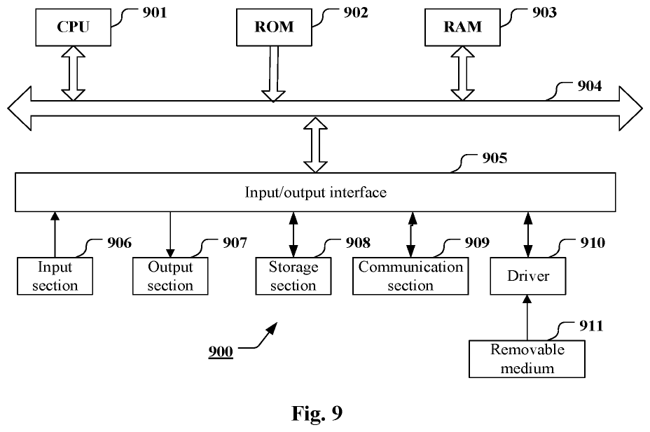

As an example, various steps of the methods above and various modules and/or units of the devices above may be implemented as software, firmware, hardware or a combination thereof. In a case of implementing by software or firmware, programs constituting software for implementing the methods above may be installed to a computer with a dedicated hardware structure (for example a general-purpose computer 900 shown in FIG. 9) from storage medium or the network. The computer can perform various types of functions when installed with various types of programs.

In FIG. 9, a central processing unit (CPU) 901 performs various types of processing according to programs stored in a read only memory (ROM) 902 or programs loaded from a storage section 908 to a random access memory (RAM) 903. Data required when the CPU 901 performs various types of processing is also stored in the RAM 903 as needed. The CPU 901, the ROM 902 and the RAM 903 are linked to each other via a bus 904. An input/output interface 905 is also linked to the bus 904.

The following components are linked to the input/output interface 905: an input section 906 (including a keyboard, and a mouse and so on), an output section 907 (including a display, for example a cathode ray tube (CRT) and a liquid crystal display (LCD), and a loudspeaker), a storage section 908 (including a hard disk and so on), and a communication section 909 (including a network interface card for example a LAN card, and a modem). The communication section 909 performs communication processing via a network for example the Internet. A driver 910 may also be linked to the input/output interface 905 as needed. A removable medium 911 for example a magnetic disk, an optical disk, a magnetic-optical disk and a semiconductor memory may be installed on the driver 910 as needed, such that computer programs read from the removable medium 911 are installed on the storage section 908 as needed.

In a case of performing the series of processing described above by software, programs constituting the software are installed from the network, for example, the Internet or the storage medium, for example, the removable medium 911.

Those skilled in the art should understand that the storage medium is not limited to the removable medium 911 shown in FIG. 9 which stores programs and is distributed separately from the device to provide the programs to the user. Examples of the removable medium 911 include: a magnetic disk (including a floppy disk (registered trademark), an optical disk (including a compact disk read only memory (CD-ROM) and a digital versatile disk (DVD), a magnetic-optical disk (including a mini disk (MD) (registered trademark)), and a semiconductor memory. Alternatively, the storage medium may be a hard disk included in the ROM 902 and the storage section 908 which stores programs. The storage medium is distributed to the user, together with the device including the storage medium.

A program product storing machine readable instruction codes is further provided according to the embodiments of the present disclosure. When read and executed by a machine, the instruction codes cause the machine to perform the method according to the embodiment of the present disclosure.

Accordingly, a storage medium for carrying the program product storing the machine readable instruction codes is further provided according to the present disclosure. The storage medium includes but not limited to a floppy disk, an optical disk, a magnetic-optical disk, a storage card and a memory stick and so on.

The embodiments of the present disclosure further relate to an electronic device in the following. In a case that the electronic device is used for the base station side, the electronic device may be implemented as any type of evolved node B (eNB), such as a macro eNB and a small eNB. The small eNB may be an eNB covering a cell smaller than a macro cell, such as a pico eNB, a micro eNB and a home (femto) eNB. Alternatively, the electronic device may be implemented as any other type of base stations, such as a NodeB and a base transceiver station (BTS). The electronic device may include: a body configured to control wireless communication (also referred to as a base station device); and one or more remote radio heads (RRH) located at positions different from the body. In addition, various types of terminals described in the following each may function as a base station to operate by performing functions of the base station temporarily or in a semi-permanent manner.

In a case that the electronic device is for user equipment side, the electronic device may be implemented as mobile terminals (such as a smart phone, a tablet personal computer (PC), a notebook PC, a portable game terminal, a portable/dongle mobile router and a digital camera) or a vehicle terminal (such as an automobile navigation device). In addition, the electronic device may be a wireless communication module installed on each of the above terminals (such as an integrated circuit module including one or more chips).

[Application Example of Terminal Device]

FIG. 10 is a block diagram showing an example of a schematic configuration of a smart phone 2500 to which the technology of the present disclosure may be applied. The smart phone 2500 includes a processor 2501, a memory 2502, a storage 2503, an external connection interface 2504, a camera 2506, a sensor 2507, a microphone 2508, an input apparatus 2509, a display apparatus 2510, a speaker 2511, a radio communication interface 2512, one or more antenna switches 2515, one or more antennas 2516, a bus 2517, a battery 2518, and an auxiliary controller 2519.

The processor 2501 may be, for example, a CPU or a system on a chip (SoC), and controls functions of an application layer and another layer of the smart phone 2500. The memory 2502 includes RAM and ROM, and stores a program that is executed by the processor 2501, and data. The storage 2503 may include a storage medium such as a semiconductor memory and a hard disk. The external connection interface 2504 is an interface for connecting an external apparatus such as a memory card and a universal serial bus (USB) apparatus to the smart phone 2500.

The camera 2506 includes an image sensor such as a charge coupled device (CCD) and a complementary metal oxide semiconductor (CMOS), and generates a captured image. The sensor 2507 may include a group of sensors such as a measurement sensor, a gyro sensor, a geomagnetic sensor, and an acceleration sensor. The microphone 2508 converts sounds that are input to the smart phone 2500 into audio signals. The input apparatus 2509 includes, for example, a touch sensor configured to detect touch onto a screen of the display apparatus 2510, a keypad, a keyboard, a button, or a switch, and receive an operation or information input from a user. The display apparatus 2510 includes a screen (such as a liquid crystal display (LCD) and an organic light-emitting diode (OLED) display), and displays an output image of the smart phone 2500. The speaker 2511 converts audio signals that are output from the smart phone 2500 into sounds.

The radio communication interface 2512 supports any cellular communication scheme (such as LTE and LTE-Advanced), and performs wireless communication. The radio communication interface 2512 may typically include, for example, a BB processor 2513 and an RF circuit 2514. The BB processor 2513 may perform, for example, encoding/decoding, modulating/demodulating, and multiplexing/demultiplexing, and performs various types of signal processing for wireless communication. Meanwhile, the RF circuit 2514 may include, for example, a mixer, a filter, and an amplifier, and transmits and receives wireless signals via the antenna 2516. The radio communication interface 2512 may be a chip module having the BB processor 2513 and the RF circuit 2514 integrated thereon. The radio communication interface 2512 may include multiple BB processors 2513 and multiple RF circuits 2514, as illustrated in FIG. 10. Although FIG. 10 shows the example in which the radio communication interface 2512 includes the multiple BB processors 2513 and the multiple RF circuits 2514, the radio communication interface 2512 may also include a single BB processor 2513 or a single RF circuit 2514.

Furthermore, in addition to a cellular communication scheme, the radio communication interface 2512 may support another type of wireless communication scheme such as a short-distance wireless communication scheme, a near field communication scheme, and a wireless local area network (LAN) scheme. In this case, the radio communication interface 2512 may include the BB processor 2513 and the RF circuit 2514 for each wireless communication scheme.

Each of the antenna switches 2515 switches connection destinations of the antennas 2516 among multiple circuits (such as circuits for different wireless communication schemes) included in the radio communication interface 2512.

Each of the antennas 2516 includes a single or multiple antenna elements (such as multiple antenna elements included in an MIMO antenna), and is used for the radio communication interface 2512 to transmit and receive wireless signals. The smart phone 2500 may include the multiple antennas 2516, as shown in FIG. 10. Although FIG. 10 shows the example in which the smart phone 2500 includes the multiple antennas 2516, the smart phone 2500 may also include a single antenna 2516.

Furthermore, the smart phone 2500 may include the antenna 2516 for each wireless communication scheme. In this case, the antenna switches 2515 may be omitted from the configuration of the smart phone 2500.

The bus 2517 connects the processor 2501, the memory 2502, the storage 2503, the external connection interface 2504, the camera 2506, the sensor 2507, the microphone 2508, the input apparatus 2509, the display apparatus 2510, the speaker 2511, the radio communication interface 2512, and the auxiliary controller 2519 to each other. The battery 2518 supplies power to blocks of the smart phone 2500 shown in FIG. 10 via feeder lines, which are partially shown as dashed lines in the figure. The auxiliary controller 2519 operates a minimum necessary function of the smart phone 2500, for example, in a sleep mode.

In the smart phone 2500 shown in FIG. 10, the transceiving device of the user equipment may be implemented by the radio communication interface 2512. At least a part of functions of the user equipment may be implemented by a processor 2501 or an auxiliary controller 2519. For example, power consumption of the battery 2518 may be reduced by performing a part of the functions of the processor 2501 by the auxiliary controller 2519. In addition, the processor 2501 or the auxiliary controller 2519 may perform at least a part of the functions of the units of the user equipment by executing programs stored in the memory 2502 or the storage 2503.

[Application Example of Base Station]

FIG. 11 is a block diagram of an example of a schematic configuration of an eNB to which the technology of the present disclosure may be applied. An eNB 2300 includes one or more antennas 2310 and a base station device 2320. The base station device 2320 and each antenna 2310 may be connected to each other via a radio frequency (RF) cable.

Each of the antennas 2310 includes one or more antenna elements (such as multiple antenna elements included in a multiple input multiple output (MIMO) antenna) and is used by the base station device 2320 to transmit and receive a wireless signal. As shown in FIG. 11, the eNB 2300 may include multiple antennas 2310. For example, the multiple antennas 2310 may be compatible with multiple frequency bands used by the eNB 2300. Although FIG. 11 shows an example in which the eNB 2300 includes multiple antennas 2310, the eNB 2300 may include a single antenna 2310.

The base station device 2320 includes a controller 2321, a memory 2322, a network interface 2323 and a radio communication interface 2325.

The controller 2321 may be a CPU or a DSP and control various functions of higher layers of the base station device 2320. For example, the controller 2321 generates a data packet based on data in a signal processed by the radio communication interface 2325, and transfers the generated packet via a network interface 2323. The controller 2321 may bind data from multiple baseband processors to generate a binding packet and transfer the generated binding packet. The controller 2321 may have logic functions for performing the following control: wireless resource control, wireless carrying control, mobility management, admission control and schedule. The control may be performed in combination with an adjacent eNB or a core network node. The memory 2322 includes RAM and ROM, and stores programs executed by the controller 2321 and various types of control data (such as a terminal list, transmission power data and scheduling data).

The network interface 2323 is configured to connect the base station device 2320 to a communication interface of the core network 2324. The controller 2321 may communication with the core network node or another eNB via the network interface 2323. In this case, the eNB 2300 and the core network node or another eNB may be connected to each other via a logic interface (such as an S1 interface or an X2 interface). The network interface 2323 may be a wired communication interface or a radio communication interface for a wireless backhaul line. If the network interface 2323 is a radio communication interface, the network interface 2323 may use a higher frequency band for wireless communication as compared with the frequency band used by the radio communication interface 2325.

The radio communication interface 2325 supports any cellular communication scheme (such as long term evolution (LTE) and LTE-advanced), and provides a wireless connection to a terminal located in a cell of the eNB 2300 via an antenna 2310. The radio communication interface 2325 may generally include a baseband (BB) processor 2326 and an RF circuit 2327. The BB processor 2326 may perform for example encoding/decoding, modulating/demodulating and multiplexing/demultiplexing, and various types of signal processing of layers (such as L1, medium access control (MAC), wireless link control (RLC) and packet data convergence protocol (PDCP)). Instead of the controller 2321, the BB processor 2326 may have a part or all of the above logic functions. The BB processor 2326 may be a memory storing communication control programs or a module including a processor configured to execute programs and a related circuit. Updating programs may change functions of the BB processor 2326. The module may be a card or a blade inserted into a slot of the base station device 2320. Alternatively, the module may be a chip installed on the card or the blade. The RF circuit 2327 may include for example a mixer, a filter or an amplifier, and transmits and receives a wireless signal via the antenna 2310.

As shown in FIG. 11, the radio communication interface 2325 may include multiple BB processors 2326. For example, the multiple BB processors 2326 may be compatible with multiple frequency bands used by the eNB 2300. As shown in FIG. 11, the radio communication interface 2325 may include multiple RF circuits 2327. For example, the multiple RF circuits 2327 may be compatible with multiple antenna elements. Although FIG. 11 shows an example in which the radio communication interface 2325 includes multiple BB processors 2326 and multiple RF circuits 2327, the radio communication interface 2325 may include a single BB processor 2326 or a single RF circuit 2327.

In the eNB 2300 shown in FIG. 11, the transceiving device of the communication apparatus for the base station side according to the embodiments of the present disclosure may be implemented by the radio communication interface 2325. At least a part of the functions of units of the communication apparatus for the base station side according to the embodiments of the present disclosure may be implemented by the controller 2321. For example, the controller 2321 may perform at least a part of the functions of the units of the communication apparatus for the base station side according to the embodiments of the present disclosure by performing the programs stored in the memory 2322.

In the description of specific embodiments of the present disclosure above, features described and/or shown for one embodiment may be used in one or more other embodiments in the same or similar manner, combined with features in other embodiments, or substitute for features in other embodiments.

It should be noted that, terms “including/comprising” used herein refer to existing of features, elements, steps or components, but existing or adding of one or more other features, elements, steps or components is not excluded.

In the above embodiments and examples, reference numerals consisting of numbers are used to indicate various steps and/or units. Those skilled in the art should understand that the reference numerals are used to facilitate describing and drawing, and are not intended to indicate an order or limit in any way.

In addition, the method according to the present disclosure is not limited to be performed in a time order described in the description, and may be performed according to other time orders, in parallel or independently. Therefore, the order in which the method described in the description is performed does not limit the technical scope of the present disclosure.

Although the present disclosure is disclosed by the description of specific embodiments of the present disclosure above, it should be understood that all the embodiments and examples described above are only schematic and are not intended to limit. For those skilled in the art, various changes, improvements or equivalents may be designed for the present disclosure within the spirit and scope of the appended claims. The changes, improvements or equivalents should be regarded as falling within the protection scope of the present disclosure.

1. A wireless communication apparatus for base station side, comprising:
a transceiving device; and
at least one processor configured to:
control, in response to a scheduling request for uplink transmission transmitted by a user equipment on a licensed frequency band, the transceiving device to detect a channel on an unlicensed frequency band;
determine, in a case where the detected channel is idle, the transceiving device to transmit scheduling information for the channel to the user equipment through a licensed frequency band; and
control the transceiving device to receive uplink data transmitted by the user equipment via the channel.

2. The wireless communication apparatus according to claim 1, wherein the processor is further configured to: control the transceiving device to suspend, for a predetermined time period during reception of the uplink data, the reception of the uplink data and broadcast a channel occupancy signal via the channel.

3. The wireless communication apparatus according to claim 2, wherein the predetermined time period is preset by a system to which the base station belongs.

4. The wireless communication apparatus according to claim 3, wherein a configuration of the predetermined time period is identical to that of at least one other base station in the system.

5. The wireless communication apparatus according to claim 1, wherein the processor is configured not to schedule the channel to the user equipment, in a case where a result of the detection on the channel indicates that the channel is occupied.

6. A wireless communication method for base station side, comprising:
detecting, in response to a scheduling request for uplink transmission transmitted by a user equipment on a licensed frequency band, a channel on an unlicensed frequency band;
transmitting, in a case where the detected channel is idle, scheduling information for the channel to the user equipment through a licensed frequency band; and
receiving uplink data transmitted by the user equipment via the channel.

7. A wireless communication apparatus for user equipment side, comprising:
a transceiving device; and
at least one processor configured to:
control the transceiving device to transmit a scheduling request for uplink transmission to a base station on a licensed frequency band;
control the transceiving device to receive scheduling information transmitted by the base station on a licensed frequency band, wherein the scheduling information is transmitted by the base station based on a detection on a channel on an unlicensed frequency band; and
control the transceiving device to transmit uplink data to the base station via the channel.

8. The wireless communication apparatus according to claim 7, wherein transmitting the uplink data comprises:
suspending transmission of the uplink data for a predetermined time period during the transmission of the uplink data.

9. The wireless communication apparatus according to claim 8, wherein the predetermined time period is preset by a system to which the base station belongs.

10. The wireless communication apparatus according to claim 7, wherein the processor is further configured to:
control, upon reception of the scheduling information, the transceiving device to perform Listen-Before-Talk on the channel; and
trigger transmission of the uplink data in a case where the channel is idle during an idle channel estimation time slot.

11. The wireless communication apparatus according to claim 7, wherein the processor is further configured to:
control, upon reception of the scheduling information, the transceiving device to perform Listen-Before-Talk on the channel; and
trigger transmission of the uplink data in a case where the channel is idle during both an idle channel estimation time slot and a subsequent random back-off process.

12. The wireless communication apparatus according to claim 11, wherein a duration of the random back-off process is selected randomly in a range of a predetermined competition window.

13. The wireless communication apparatus according to claim 11, wherein the processor is further configured to:
perform, in a case where the channel is detected to be occupied during the random back-off process, a new random back-off process with a duration randomly re-selected in the range of the predetermined competition window.

14. The wireless communication apparatus according to claim 11, wherein the processor is further configured to:
adjust, in a case where the channel is detected to be occupied during the random back-off process, a size of the competition window and perform a new random back-off process with a duration randomly re-selected in a range of a new competition window.

15. The wireless communication apparatus according to claim 14, wherein adjusting the size of the competition window comprises doubling the size of the competition window.

16. A wireless communication method for user equipment side, comprising:
transmitting a scheduling request for uplink transmission to a base station on a licensed frequency band;
receiving scheduling information transmitted by the base station on a licensed frequency band, wherein the scheduling information is transmitted by the base station based on a detection on a channel on an unlicensed frequency band; and
transmitting uplink data to the base station via the channel.
